(19) United States
(12) Patent Application Publication
(10) Pub. No.: US 2008/0288622 A1
(43) Pub. Date: Nov. 20, 2008

(54) Managing Server Farms

(75) Inventors: Andrew D. Gordon, Cambridge (GB); Karthikeyan Bhargavan, Cambridge (GB); Iman Narasamdya, Manchester (GB)

Correspondence Address: LEE & HAYES PLLC, 421 W RIVERSIDE AVENUE SUITE 500, SPOKANE, WA, 99201, US

(73) Assignee: Microsoft Corporation, Redmond, WA (US)

(21) Appl. No.: 11/750,964

(22) Filed: May 18, 2007

(51) Int. Cl. G06F 15/16; G06F 9/455; G06F 9/46

(52) U.S. Cl. 709/223; 718/1; 718/105; 719/318

(57) ABSTRACT

Manual management of server farms is expensive. Low-level tools and the sheer complexity of the task make it prone to human error. By providing a typed interface using service combinators for managing server farms it is possible to improve automated server farm management. Metadata about a server farm is obtained, for example, from disk images, and this is used to generate a typed environment interface for accessing server farm resources. Scripts are received, from a human operator or automated process, which use the environment interface and optionally also pre-specified service combinators. The scripts are executed to assemble and link together services in the server farm to form and manage a running server farm application. By using typechecking server farm construction errors can be caught before implementation.

### COPYRIGHT NOTICE

A portion of the disclosure of this patent contains material which is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

### BACKGROUND

The use of server farms is increasingly widespread for many purposes such as hosting web sites, running compute jobs, providing search engine facilities and providing web-based services. Server farms typically comprise several computer servers managed by a single entity such as an enterprise in order to collectively provide capability far beyond that of a single machine. The servers may be located at the same geographical location but this is not essential; they may be distributed over a communications network.

Very large server farms having thousands of processors may be limited by the performance of cooling systems provided at the server farm site (in the case that they are co-located). Failure of individual machines is commonplace and this means that management of server farms is a particular problem. Management of server farms not only involves fault management and maintenance but also, load balancing, provision and interconnection of servers. These management issues also apply to smaller server farms having tens of servers and even to server farms having only one server which comprises two or more virtual machines.

Conventionally, system administrators manage server farms using command prompts, scripts, graphical tools and actual physical configuration. This is time consuming, complex, error prone and requires expert system administrators. For example, a system administrator may make an interconnection error at initial configuration of a server farm, or during subsequent reconnections. Interconnection errors produce faults which must be addressed before the server farm can function correctly.

The invention is not intended to be limited to implementations which solve any or all of the above noted problems.

### SUMMARY

The following presents a simplified summary of the disclosure in order to provide a basic understanding to the reader. This summary is not an extensive overview of the disclosure and it does not identify key/critical elements of the invention or delineate the scope of the invention. Its sole purpose is to present some concepts disclosed herein in a simplified form as a prelude to the more detailed description that is presented later.

Manual management of server farms is expensive. Low-level tools and the sheer complexity of the task make it prone to human error. By providing a typed interface using service combinators for managing server farms it is possible to improve automated server farm management. Metadata about a server farm is obtained, for example, from disk images, and this is used to generate a typed environment interface for accessing server farm resources. Scripts are written to manage the server farm, which use the environment interface and optionally also pre-specified service combinators. The scripts are executed to assemble and link together services in the server farm to form and manage a running server farm application. By using typechecking server farm construction errors can be caught before implementation.

Many of the attendant features will be more readily appreciated as the same becomes better understood by reference to the following detailed description considered in connection with the accompanying drawings.

### DESCRIPTION OF THE DRAWINGS

The present description will be better understood from the following detailed description read in light of the accompanying drawings, wherein:

FIG. 1 is a block diagram of an example method of managing a server farm;

FIG. 2 is a schematic diagram of an example server farm managed using a server farm management system;

FIG. 3 is a schematic diagram of a server farm providing an enterprise order processing application;

FIG. 4 is a schematic diagram of another server farm providing an enterprise order processing application;

FIG. 5 is a schematic diagram of another server farm providing an enterprise order processing application and formed using Par and Or service combinators;

FIG. 6 is a schematic diagram of another server farm providing an enterprise order processing application and formed using a Ref service combinator;

FIG. 7 is a schematic diagram of a server farm having virtual machines;

FIG. 8 shows an example method of generating a manager for managing a server farm;

FIG. 9 illustrates an exemplary computing-based device in which embodiments of a server farm management system may be implemented. Like reference numerals are used to designate like parts in the accompanying drawings.

### DETAILED DESCRIPTION

The detailed description provided below in connection with the appended drawings is intended as a description of the present examples and is not intended to represent the only forms in which the present example may be constructed or utilized. The description sets forth the functions of the example and the sequence of steps for constructing and operating the example. However, the same or equivalent functions and sequences may be accomplished by different examples.

Although the present examples are described and illustrated herein as being implemented in a small scale server farm having a single host machine comprising a plurality of virtual machines managed by a virtual machine monitor, the system described is provided as an example and not a limitation. As those skilled in the art will appreciate, the present examples are suitable for application in a variety of different types of server farms comprising a plurality of servers where those servers may be physical machines or may be virtual machines. Also, although the present examples are described with reference to a server farm providing an enterprise order processing application, these are examples and not a limitation. A server farm for implementing any one or more applications may be managed using the methods and systems described herein.

The term “server farm” is used herein to refer to one or more servers which may be physical computer servers or may be virtual machines which are arranged to collectively implement one or more functions. The servers in the farm may be located at the same geographical location or may be remote from one another and in communication via a communications network. Servers within a farm may have both local and remote dependencies. For example, a remote dependency may comprise an ability to receive requests from remote clients, such as a web browser. Another example of a remote dependency is the ability to send requests to remote servers, to perform a credit card transaction, for example. An example of a local dependency is the ability to send and/or receive requests from other servers within the farm. For example, a front end web server may send a request to a database server.

Each server in the server farm is arranged to boot off a disk image such as the contents of a local hard drive or an image fetched over a network. In the case that a server of the server farm comprises a virtual machine, the disk image may be the virtual disk drive space used by that virtual machine. The disk image comprises a computer file containing the complete contents and structure of a data storage medium or device. The data storage medium or device may be a physical storage medium or may be virtual as mentioned above.

In the present application, each server is considered as playing a particular role, such as web server, mail server, application server or other role. At any time two or more servers in the farm may have the same role and in this case the disk images of the relevant servers are assumed to be essentially the same except for small differences such as machine names, security identifiers and licensing data.

By providing a method and system for representing such server roles using typed functions at least some embodiments of the invention are able to provide improved methods and systems for managing server farms.

Each server role is described as importing and/or exporting services where a service is itself described as a set of one or more endpoints. An endpoint is a communications port associated with a server in the farm which provides functionality via a message protocol such as request/response. For example, an endpoint may be a port to which a request may be sent, and a response received from, on a remote entity outside the server farm to perform a credit card transaction. Another example of an endpoint is a port to which a request may be sent on another server in the farm to retrieve a database entry.

At least some embodiments of the invention involve representing server roles in terms of services that are imported or exported. A server role is described as implementing its exports and having dependencies on its imports. That is, exports of a server role comprise functions carried out by that server itself and which it may provide to others. An example is a database function provided by a server. Imports of that server may comprise results of services it receives from other entities. The imports and exports are assigned explicit types which describe message contents and message patterns. For example, an order processing application implemented collectively at a server farm may have an order entry role provided by one of the servers in the farm. That server role (order entry) may be represented using typed functions as follows. The server provides an order entry service which it exports.
public interface IOrderEntry {string SubmitOrder(Order order);}

A request sent to the exported endpoint represents an invocation of the SubmitOrder method, including a value of type Order. The response includes the result, a string. The code for SubmitOrder needs to consult a remote site to make an authorization decision. Hence, the server role has a dependency on the following IPayment interface (its import).
public interface IPayment {string AuthorizePayment(Payment payment);}

As mentioned above, at least some embodiments of the invention involve representing server roles of a server farm in terms of one or more services they import and/or export. Using these representations scripts are written optionally also using service combinators which are pre-specified typed functions, methods or procedures. The scripts may then be executed to manage a server farm.

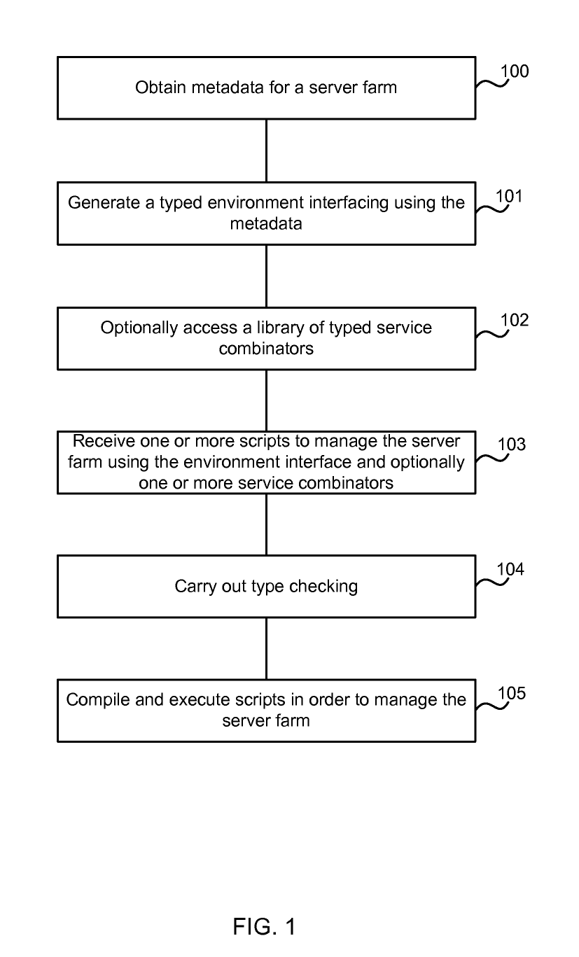

FIG. 1 is a high level block diagram of a method of managing a server farm. Metadata is first obtained for the server farm (block 100). This metadata comprises, for each server role, information about that role and about endpoints associated with that server role. For example, the metadata for a server farm comprises:

the input and output types for each endpoint implemented by each server role;

information about any external endpoints that the server farm can use; and information about any endpoints that the server role may be exported to.

Using the metadata a typed environment interface is generated (block 101). This environment interface may be considered as an application programming interface to the disk images and endpoints.

A pre-specified library of typed service combinators is available. These combinators are methods, functions or procedures that may be used to assist in managing a server farm. For example, a particular service combinator may be used for load balancing and another for improving reliability. More detail about service combinators is given below. Optionally, the library of typed service combinators is accessed (block 102).

One or more scripts are received (block 103) which have been formed using the environment interface and, optionally, one or more of the service combinators. For example, the scripts are written by an operator in order to assemble and link together the disk images to form a running server farm and manage its evolution over time. Type checking is then carried out (block 104) in order to identify any construction errors in the proposed server farm before implementation of that server farm. After correction of any identified errors the scripts are compiled and executed in order to construct and/or manage the server farm (block 105).

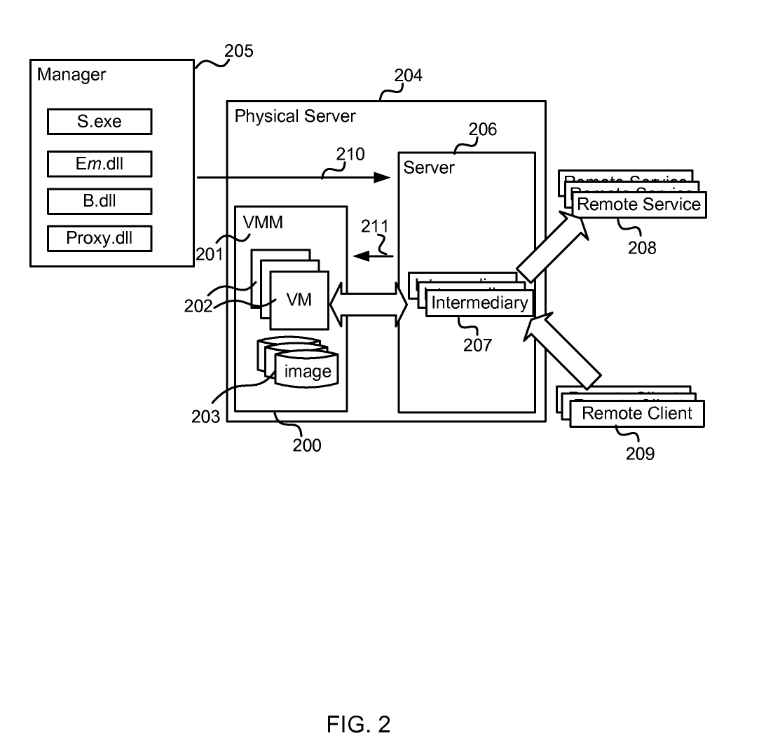

FIG. 2 is an example of a server farm 200 arranged to be managed as described herein. In this example the server farm comprises a plurality of servers which in this case are virtual machines 202 each having a disk image 203 and each being hosted by a virtual machine monitor (VMM) on a single physical server 204. Any suitable virtual machine monitor may be used such as those currently commercially available. In this example, the server farm is managed using a manager 205 provided using software (for example, the scripts mentioned above) executed on the physical server 204 itself or at another processor in communication with the physical server 204. The manager 205 controls a server 206 (as indicated by arrow 210) which may be a process running on the physical server 204. That server 206 in turn controls (as indicated by arrow 211) the server farm 200 via the virtual machine monitor 201.

The server 206 may comprise one or more intermediaries 207 which are in data flow communication with the virtual machines 202 and which are able to send data to remote services 208 and receive data from remote clients 209. For example, a remote client 209 is a consumer of a service located at an endpoint on the physical server 204. A remote service 208 is a service which may be called by computations running on the physical server 204.

The physical server 204 hosts both the Server 206, and the virtual machine monitor VMM. The Manager 205 is an executable compiled from a script; it manages the Server 206 (and hence the VMM 201) using remote procedure call, and hence may run either on the physical server 204, or elsewhere.

The Server 206 is a process running on the physical server 204. It implements endpoints exported by the physical server, as well as endpoints associated with intermediaries 207. In some examples, the Server 206 mediates all access to remote services 208, and implements intermediaries 207 as objects. However, it is not essential for the server to mediate all access to remote services. It is also possible for directional dataflow between the virtual machines and the external clients and services to be implemented. The VMM 201 also runs on the physical server 204, under control of the Server 206. The disk images 202 and other files, such as snapshots, used by the VMM 201 are held on disks mounted on the physical server 204.

The VMM 201 may host a virtual network to which each VM 202 is attached via a virtual network adapter. The virtual network may be attached to the physical server's networking stack using a loopback adapter. The result is to isolate the VMs from the external network. Remote clients 209 can directly call services hosted in the Server 206, but not those hosted in VMs. Services hosted in the Server 206 can directly call each other, services in VMs, and remote services 208. VMs can call services on each other, or services hosted in the Server 206, but cannot directly call remote services 208.

Particular examples are now given of a system for managing a server farm. In these examples the servers of the server farm import and export simple object access protocol (SOAP) endpoints with web services description language (WSDL) metadata and the service combinators are functions in the F# dialect of ML. SOAP is described in detail in SOAP Version 1.2 W3C Working Draft 9 Jul. 2001 (and later versions), however other versions of SOAP may be used, including previous versions 1.0 and 1.1. WSDL is described in detail in “Web Services Description Language (WSDL) Version 1.1 W3C (and later versions) edited by Christensen, Curbera, Meredith and Weerawarana. However, it is not essential to use servers which import and export SOAP endpoints and to have WSDL metadata and service combinators which are provided as functions in the F# dialect of ML. Any other suitable message protocols, description languages and programming languages may be used. For example, open database connectivity (ODBC) may be used in place of SOAP with types being obtained from proxy dynamic link libraries (DLLs). Any NET type scheme may be used. It may also be possible to use CORBA IDL and DCOM.

Using conventional development tools suitable disk images may be constructed comprising software to implement each server role required in a server farm. For example, there are many development tools and software platforms available for producing service-oriented disk images, where the imports and exports are described with WSDL. Metadata may be included in each disk image (or held in an associated file rather than within the disk image file itself) comprising information about endpoints exported by and imported from a machine booted off that disk image, and also comprising, a program to be run whenever a virtual machine boots that communicates endpoint addresses to the server farm manager.

For example, consider a server farm which is required to implement an order processing application. The order processing application is provided in a programming language of any suitable type which is able to exchange SOAP messages and to map between its own interfaces and WSDL metadata.

More detail about the environment interface is now given.

The following example relates to internal endpoint types. In this example, a value of type (α, β) endpoint is the network address of a SOAP endpoint, hosted either on the physical server (204 of FIG. 2) or on one of the managed VMs (202 of FIG. 2). The endpoint expects SOAP requests and returns SOAP responses whose bodies correspond to the ML types α and β, respectively.

The following function makes a call to an endpoint. Given an (α, β) endpoint and a request of type a, it serializes the request into a SOAP message, sends it to the endpoints, awaits and then deserializes the response, and returns the result as a value of type β. It is useful, for example, for running tests.

val call: (α, β) endpoint→α→β

In another example, a disk image is provided implementing the order entry role described above. The disk image has metadata about the server role, including WSDL descriptions of the exported and imported endpoints, corresponding to the IOrderEntry and IPayment interfaces, respectively.

From this metadata m a typed management interface is generated (block 101 of FIG. 1), named Em. This interface includes ML types corresponding to the WSDL request and response types for each service:

type tPayment=(Payment,string) endpoint

type tOrderEntry=(Order,string) endpoint

The ML definitions of the Order and Payment types correspond to the types mentioned in the interfaces used to implement this service on this particular disk image. There is however no direct dependency on the implementation language of the service; the ML types are generated from the WSDL description, which itself can be generated from a wide range of implementation languages.

The Em interface in this example also includes a function for booting a fresh VM from the disk image. This operator is a function that given the imported endpoint returns the exported endpoint. It also returns a fresh VM identifier, of type vm_name, for use in establishing event handlers, for example.

val createOrderEntryRole:tPayment→(vm×tOrderEntry)

The disk image may be stored as an ordinary file. A VMM such as Virtual Server offers a function to boot a VM off such a file. Our createOrderEntryRole function is a higher-level abstraction that knows the path to the disk image, boots a VM using the disk image as a fresh virtual disk, configures the VM with a tPayment endpoint, and eventually returns a tOrderEntry endpoint.

A key feature of this approach is that instead of presenting disk images as files, code is generated, like createOrderEntryRole, that presents disk images as functions manipulating typed endpoints. Hence, type checking catches interconnection errors that would otherwise cause failures at run time, either during initial configuration or later during reconfigurations.

Another example concerns typed access to external endpoints. In some embodiments it is required to refer to external URIs and to implement services at fixed URIs on the server (206 of FIG. 2). These may be declared together with their endpoint types as part of the metadata used to generate the environment interface or Em module.

For example, the Em module includes the following typed function to give access to a remote payment service. The URI itself is declared in metadata.

val importPayment:unit→tPayment

Similarly, Em includes a function for exporting a service endpoint on an externally addressable port on the server 206. The actual port is declared in metadata.

val exportOrderEntry:tOrderEntry→unit

Since VMs are not directly attached to the external network, both these functions create intermediaries 207 on the server 206 that relay between the internal endpoints and the external network.

An Example Script The following example builds a server farm consisting of two instances of the order entry role, exposed externally via a load-balancing intermediary, and with a dependency on an external payment service.

let ep0=importPayment( )

let (vm1,ep1)=createOrderEntryRole ep0

let (vm2,ep2)=createOrderEntryRole ep0

let ep3=eOr ep1 ep2

let ( )=exportOrderEntry ep3

Line 1 binds endpoint ep0 to the external payment service. Lines 2 and 3 create two distinct instances of the order processing role; both have dependency on ep0. Line 4 calls a service combinator eOr to create a load balancing intermediary at ep3; messages sent to ep3 are forwarded either to ep1 or to ep2. Finally, line 5 makes the service at ep3 remotely accessible.

Types are inferred during typechecking.

ep0: tPayment

vm1, vm2: vm name

ep1, ep2, ep3: tOrderEntry

This example illustrates the use of two VMs in the same role to try to fully utilise dual processor hardware which may be provided at the physical server 204. Service combinators are provided for other operations to support VM snapshots, event handling, and other intermediaries as described in more detail below.

Some more examples of the use of service combinators are now given.

The basis of these examples is some published code for enterprise order processing (EOP), a case study in a book on distributed programming with XML web services (Pallmann, 2005 “Programming Indigo: the code name for the Unified Framework for building service-oriented Applications on the Microsoft Windows Platform” Microsoft Press). The example code relies on the Windows Communication Foundation (WCF), a service-oriented programming model included in version 3 of the .NET Framework.

In its simplest form, the application consists of three services: (1) a payment service for authorizing payments; (2) an order processing service for storing orders; and (3) an order entry service that takes orders along with their payments, verifies the payments using the payment service, and fulfils the orders by calling the order processing service. The interfaces for the order entry and payment services have been given earlier in this document. The interface for the order processing service is as follows:
public interface IOrderProcessing {void SubmitOrder(Order order);}

The example code for each of these three services is installed in a separate disk image; each disk image contains a server operating system of any suitable type and hosts one of the example services as an XML web service.

In other examples, instead of the internal payment service, the order entry service may use an external payment service, hosted elsewhere on the web. For example, two such payment services, Payment1 and Payment2, are available for this purpose. The order entry service may be available as an endpoint OrderEntry on the web.

In this example, metadata is obtained which describes three service endpoints (in terms of input and output types), three disk images (each implementing one service endpoint), two external payment endpoint addresses, and one exported order entry endpoint address. This metadata may be collected from XML files included in disk images, from WSDL files describing endpoints, and from hand-written application configuration files.

The metadata is compiled to an ML module containing a collection of types and functions. The types are ML representations of the request and response types in the WSDL descriptions of endpoints. The functions provided typed access to the various resources. (The full details of the metadata compiler are described below.) In this case, a module Em-c.ml is obtained that contains the functions described in the following interface, Em.mli.

### Environment Interface: Em.mli

type tPayment=(Payment,string) endpoint
type tOrderEntry=(Order,string) endpoint
type tOrderProcessing=(Order,unit) endpoint
val createOrderEntryRole:tPayment->tOrderProcessing->(vm×tOrderEntry)
val createOrderProcessingRole:unit->(vm×tOrderProcessing)
val createPaymentRole:unit->(vm×tPayment)
val importPayment1: unit->tPayment
val importPayment2: unit->tPayment
val exportOrderEntry:tOrderEntry!unit

### Example: Creating an Isolated VM Farm

A first example is an instance of the EOP system mentioned above, where the three server roles are all implemented as VMs on the server 206.

The example script below calls the functions createVMOrderProc and createVMPayment to boot VMs from the disk images of the order processing and payment roles. These calls return the endpoints e1 and e2 exported by these roles. These roles import no endpoints so the corresponding functions need no endpoints as parameters. The third line boots a VM for the order entry role, dependent on e1 and e2.

let (vm1,e1)=createOrderProcessingRole ( )

let (vm2,e2)=createPaymentRole ( )

let (vm3,e3)=createOrderEntryRole e2 e1

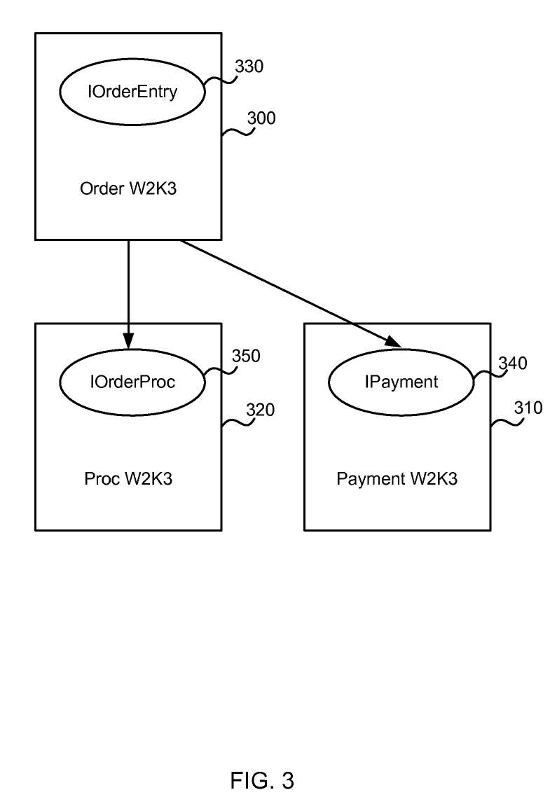

The state after running the script is shown in FIG. 3. Each VM is a rectangle 300, 310, 320 labelled with the name of the disk image. The ellipses 330, 340, 350 within a VM show its exported endpoints. The arrows from a VM show its imported endpoints.

### Example: Importing and Exporting Services

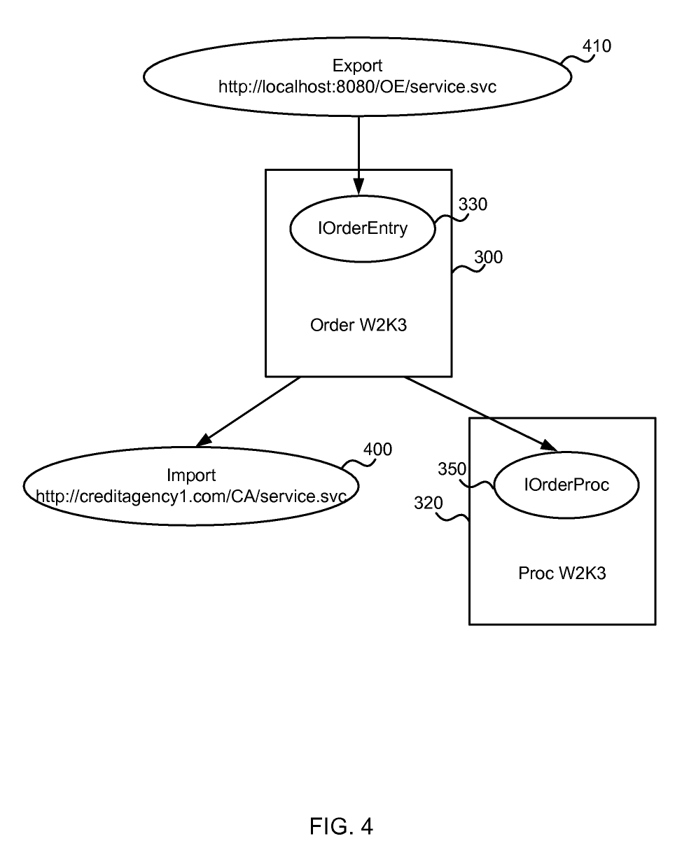

This example illustrates a deployment of the EOP system. An internal endpoint is published as a public service on the server (206 of FIG. 2). Moreover, instead of using a local payment service to authorize orders, a remote service is used. This is illustrated in FIG. 4 which shows two VMs 300, 320, one with an order role 300 and one with an order processing role 320. The VM providing the order role 300 imports a payment service from endpoint 400. In addition, the VM providing the order role 300 exports its own order entry service at endpoint 410 so that entities remote of the server farm are able to access this order service.

The external addresses of the public service and the payment services are as specified in XML metadata, and named Payment1 and OrderEntry. These addresses correspond to the typed functions importPayment1 and exportOrderEntry in the Em module.

The script below calls the function importPayment1 to create a forwarder on the server (206 FIG. 2), returning the internal endpoint ei. Any requests sent to ei are forwarded to the external URI specified in the metadata file. Similarly, the call to the function exportOrderEntry with parameter e2 creates a forwarder on the server (206 FIG. 2). Any requests sent to the server (206 FIG. 2) on the external URI named OrderEntry in the metadata file are forwarded to the internal endpoint e2.

The state after running the script below is illustrated in FIG. 4.

let ei=importPayment1 ( )

let (vm1 e1)=createOrderProcessingRole ( )

let (vm2,e2)=createOrderEntryRole ei e1

let=exportOrderEntry e2

### Example: Par and Or Intermediaries

Servers may be overloaded during office hours, but relatively unloaded in the evening. Being overloaded increases latency and can reduce the reliability. Suppose there are two sites hosting a payment authorization service, and that they are distributed geographically so that when one location is in office hours, the other is not. If only one remote endpoint is used for the payment service, there may be times when order entry service becomes unreliable because of its dependence on a highly loaded payment service.

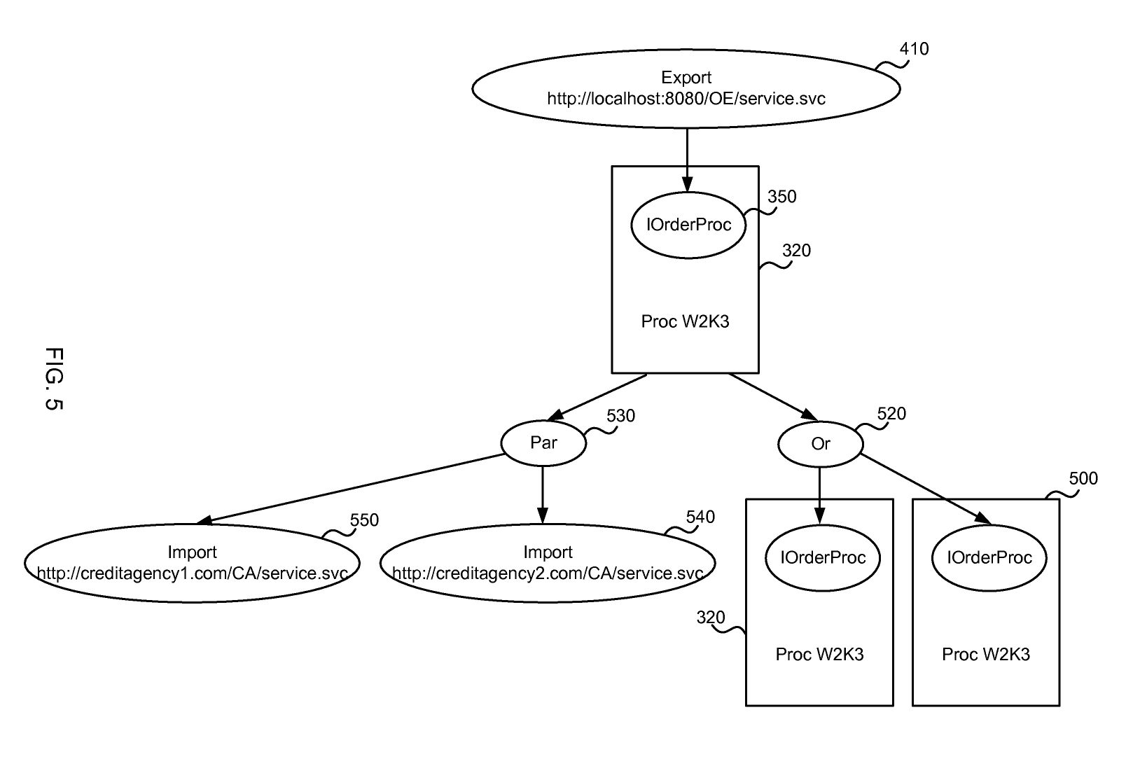

To improve the reliability of the whole service, parallelism may be used. For example, requests for the payment service are sent to both remote servers; the first response is accepted, while the second, if it arrives, is discarded. A pre-specified service combinator may be used in this situation. For example, a service combinator ePar ei1 ei2 is specified and returns an endpoint exported by a freshly created Par intermediary 530 of FIG. 5, which follows this parallel strategy. The intermediary forwards any message sent to its endpoint to both ei1 550 and ei2 540, and returns whichever result is received first. The script below uses ePar to parallelize access to the two URIs for payment services in an example metadata file.

Another use of parallelism is to “scale out” a role, by running multiple instances in parallel, together with some load balancing mechanism. Another combinator is specified, eOr e1 e2 which returns an endpoint exported by a freshly created Or intermediary, which acts as a load balancer. The intermediary 520 forwards any message sent to its endpoint to either ei1 or ei2, chosen according to any suitable strategy. The example script below calls createVMOrderProc twice to create two separate VMs 320, 500 in the order processing role, and then calls eOr to situate a load balancer in front of them. (Two VMs better utilize a dual processor machine than one.)

let ei1=importPayment1 ( )

let ei2=importPayment2 ( )

let epar=ePar ei1 ei2

let (vm1 e1)=createOrderProcessingRole ( )

let (vm2,e2)=createOrderProcessingRole ( )

let eor=eOr e1 e2

let (vm3,e3)=createOrderEntryRole epar eor

let=exportOrderEntry e3

FIG. 5 shows the state after running this script. In this case, Par and Or intermediaries 520, 530 are directly hosted as objects on the server (206, FIG. 2), so they appear outside the VM boxes.

### Example: References, Updating References, and Events

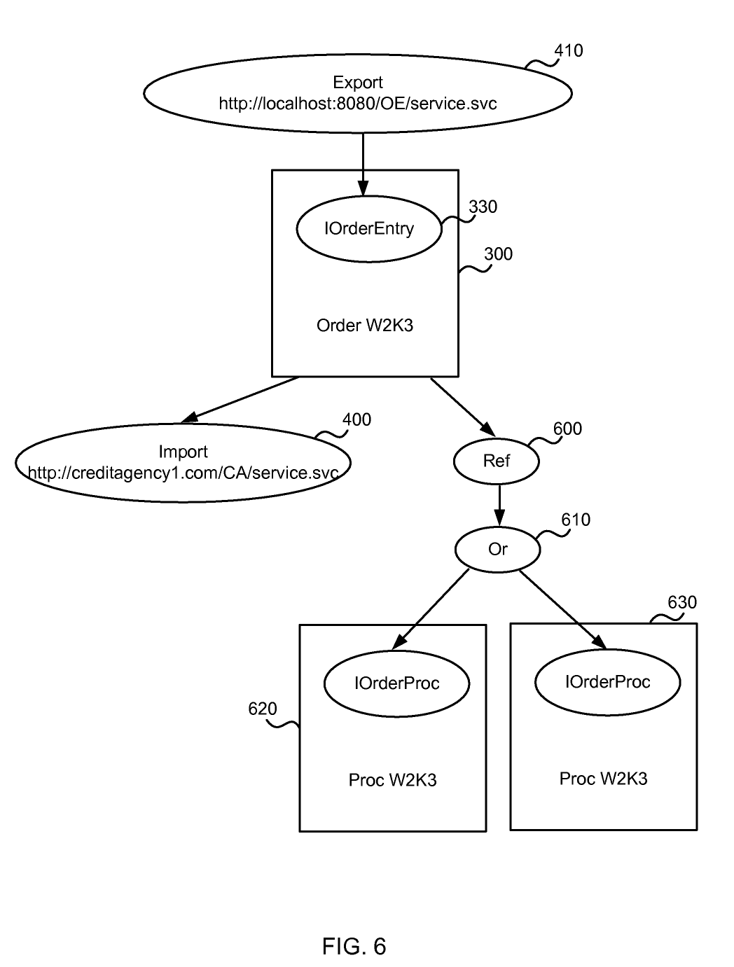

It is also possible to change the communication topology in response to an event. This is now described with reference to FIG. 6.

The combinator eRef e is specified which returns an endpoint exported by a freshly created Ref intermediary 600, together with an identifier r for the intermediary. The Ref intermediary 600 forwards any request sent to its endpoint to e. The endpoint e can be updated; a call to the combinator eRefUpdate r e′ updates the r intermediary to forward subsequent requests to e′.

A VMM, such as Virtual Server, can detect various events during the execution of a VM, such as changes of VM state, the absence of a “heartbeat” (likely indicating a crash), and so on. Embodiments of the invention provide a simple event handling mechanism, to allow a script to take action when an event is detected by the underlying VMM. A function eVM vm h is specified which associates a handler function h with a machine named vm. The handler function is of type event→unit where event is a datatype describing the event.

To illustrate these operators, consider the use in the previous example (described with reference to FIG. 5) of two instances of the order processing role 320, 500 combined via an Or intermediary 520. If one of the machines crashes, it is possible to reconfigure to avoid sending messages to the crashed machine. The code in the following script creates a Ref intermediary 600 forwarding to an Or intermediary 610 forwarding to two machines vm1 620 and vm2 630. FIG. 6 shows the connectivity at this point. The code also adds an event handler. In the event of either VM crashing, the handler updates the load balancer endpoint held by the Ref intermediary 600 to the endpoint exported by the order processing service on the other VM.

The whole process described above is scripted as follows.

let ei1=importPayment1 ( )

let (vm1,e1)=createOrderProcessingRole ( )

let (vm2,e2)=createOrderProcessingRole ( )

let eor=eOr e1 e2

let (eref,r)=eRef eor

let (vm3,e3)=createOrderEntryRole ei1 eref

let=exportOrderEntry e3

let h e ev=match ev with
VM Crash->eRefUpdate r e

let=eVM vm1 (h e2)

let=eVM vm2 (h e1)

### Example: Snapshots of VMs

When a VM has been booted from a disk image, the current state of the running VM consists of the memory image plus the current state of the virtual disk. Some VMMs, including Virtual Server, allow the current state of a VM to be stored in disk files; typically, the memory image is directly stored in one file, while the current state of the virtual disk is efficiently represented by a “difference disk”, which records the blocks that have changed since the machine started. This file system representation of a VM state is referred to herein as a snapshot. A snapshot can be saved, and subsequently restored, perhaps multiple times.

Some embodiment of the invention includes a facility for saving and restoring snapshots. If vm is a running VM, snapshotVM vm creates a snapshot, and returns an identifier for the snapshot as a value of type vm_snapshot. If ss is the identifier, restoreVM ss discards the current state of vm, and replaces it by restoring the snapshot. (These operators do not allow two snapshots of the same VM to run at once. The createVM functions in Em.ml can be called repeatedly to create multiple instances of any one role.)

It is also possible to record a snapshot of each VM just after booting and modify the event handler to restore the snapshot if the machine subsequently crashes. Snapshots allow faster recovery then rebooting.

let svm1=snapshotVM vm1

let svm2=snapshotVM vm2

let h s ev=match ev with
VM Crash->restoreVM s

let=eVM vm1 (h svm1)

let=eVM vm2 (h svm2)

### Service Combinator Interface

An example of a fixed part of a service combinator interface or application programming interface (API) is now given:

Service Combinator API: B.mli

type vm

type vm snapshot

type event=VM Crash

type (a,b) endpoint

type (a,b) endpointref

val eOr: (a,b) endpoint->(a,b) endpoint->(a,b) endpoint

val ePar: (a,b) endpoint->(a,b) endpoint->(a,b) endpoint

val eRef: (a,b) endpoint->(a,b) endpoint×(a,b) endpointref

val eRefUpdate: (a,b) endpointref->(a,b) endpoint->unit

val eVM:vm->(event->unit)->unit

val snapshotVM: vm->vm_snapshot

val restoreVM:vm_snapshot->unit

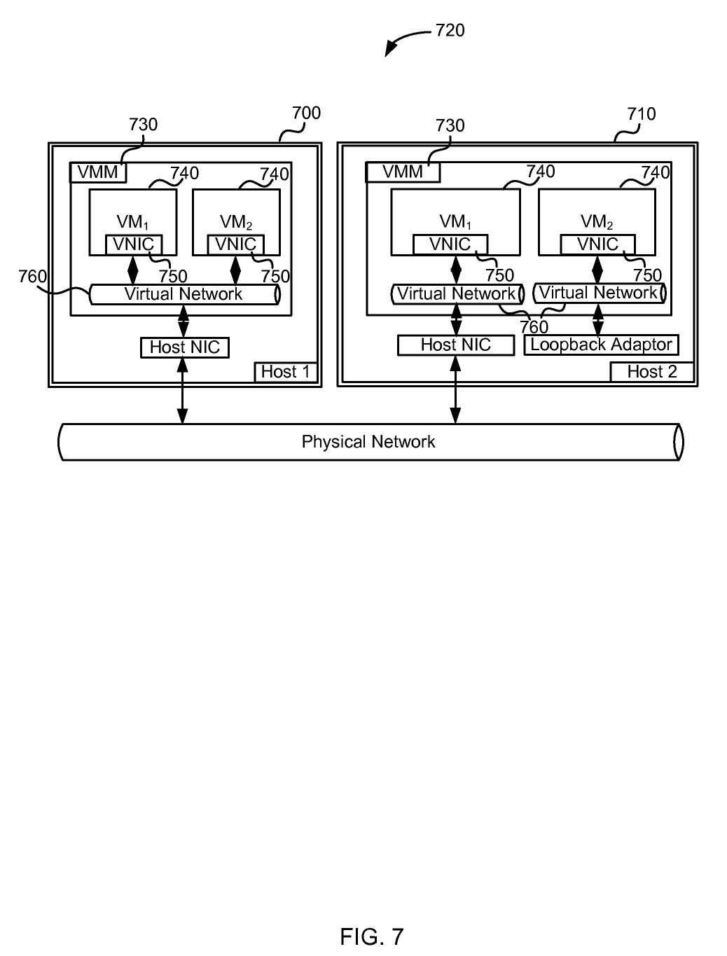

FIG. 7 shows an example of server virtualization in a server farm 720. In server virtualization each host server 700, 710 has a Virtual Machine Monitor (VMM) 730 that allows multiple operating systems to run on the host server at the same time. A Virtual Hard Disk (VHD) is a file that appears to a Virtual Machine (VM) as if it is a physical hard disk attached to a physical disk controller. Some VMMs have a feature called differencing VHD, which is a VHD that stores only the changes that the VM has made relative to its base VHD. Differencing disks can increase manageability, especially when multiple VMs share a similar configuration, and can dramatically reduce the amount of disk space required on a Virtual Server host computer. Multiple VMs 740 can communicate with each other through Virtual NIC (VNIC) 750 and Virtual Network (VN) 760. Example Implementation of the service combinator API: B-c.ml

In an example, the types in B.mli are implemented as follows.

A value of type vm is a VM identifier, as defined by the VMM.

A value of type vm_snapshot is a group of files implementing a VM snapshot.

A value of type (α, β) endpoint is a SOAP address, as defined by WCF, assumed to reference either the virtual network or the physical server, and hence usable either by a VM or an intermediary in the Server (206 of FIG. 2).

A value of type (α, β) endpointref is a mutable intermediary in the Server.

The functions in B-c.ml may be implemented as remote procedure calls, via proxy code, to the Server (206, FIG. 2). They are able to create and manipulate intermediaries (207) in the Server as described above.

More detail about the server 206 of FIG. 2 is now given:

The server 206 is able to manage VMs 202 using a Virtual Server API or any other suitable interface. For example, many VMMs are scriptable via an API as known in the art. The server 206 also creates a service host and generates a fresh address to name the endpoint of each intermediary 207. The server 206 maintains two mappings:
vhdreg which maps VMMAC addresses to services that the VMs' disk images depend on and expose; and
fwd which maps intermediary endpoints to objects implementing the intermediaries.

MAC addresses are used by the server 206 and the VMs 202 to communicate endpoints during the creation of the VMs 202. The role of MAC addresses in the creation of VMs is described in more detail below. Intermediaries 207 are services that run on the server 206. For example, let s_3=eOr s_1 s_2. In this example, when a message comes to S3 through the endpoint ep that it exposes, then the object o implementing the intermediary S3 must forward the message to either s1 or S2. The mapping fwd is used to record the association between the endpoint of an intermediary 207 and an object implementing that intermediary.

Creating VMs 202. Recall that a disk image can be viewed as a function that takes endpoints it depends upon and returns the endpoints that it exposes. The path to the disk image is treated herein as its function name. For example, given the path f and a list of endpoints \vec{s} that the image depends upon:

(1) The manager 205 calls the server 206 with argument f and \vec{s}.

(2) Using the Virtual Server API, the server 206
(a) creates differencing disk image from f;
(b) creates VNIC and obtains a MAC address c; and
(c) creates a new VM with fresh name vm;

(3) The server 206 registers c [symbol] (\vec{s},[ ]) on vhdreg.

(4) The server 206 boots the new VM vm. During start-up, the VM triggers publish.exe to fire:
(a) publish.exe tells the server 206 a list of endpoints \vec{s} 0 that vm exposes;
(b) The server 206 updates the mapping of c to c 7! (\vec{s}, \vec{s} 0);
(c) The server 206 returns˜s to publish.exe; and
(d) publish.exe modifies the configuration files of executables listed in the service conf key, and runs those executables.

(5) The server 206 returns (vm, \vec{s} 0) to the manager 205.

Creating Intermediaries. All kinds of intermediary 207 function as a message forwarder that routes messages from one endpoint to other endpoints. An example process of creating an intermediary 207 using eOr is now described; creating other kinds of intermediary is similar. Given two endpoints s1 and s2:

(1) The manager 205 calls the server 206 with arguments s1 and S2.

(2) The server 206 creates a service object o=Or(s₁, S2) that functions as a message router.

(3) The server 206 creates a new endpoint s for o, and also creates a service host to run the service object.

(4) The server 206 registers s [symbol] o on the mapping fwd, and returns s to the client.

In some embodiments of the invention a metadata compiler is provided (referred to herein as “Generator”) which takes metadata and generates a typed environment interface. More detail about this process is now given.

In an example, Generator collects metadata describing the disk images, the internal services, and the external endpoints in an application and compiles them to the following ML files:
Em.mli: a typed environment interface for use in scripts; and
Em-c.ml: a module implementing Em.mli

In order to obtain the metadata disk images are prepared or are accessed in a pre-prepared form. Any conventional development tools may be used to construct disk images containing software that implements each service. Each disk image also comprises for example:
metadata concerning the endpoints exposed by and needed by the VM booted off the disk image, and
a program called publish.exe that runs during the start-up of the VM and communicates endpoints with the server 206.

Having prepared the disk images, users (either human or automated users) are able to write scripts of programs to assemble and link together services residing on the disk images to form a running system within VMM, and to manage its evolution over time. The metadata may be placed as part of an XML configuration file of publish.exe. For example, the following is the metadata in the configuration file of publish.exe in the disk image containing order entry service:

<appSettings>
<add key=“service_conf” value=“entry.exe”/>

</appSettings>

The value of service_conf is a list of executable files that implement the services the image wants to expose. Through the name of the executable file, it is possible to find the configuration file of the order entry service, and modify the file, in the section that lists the dependency of the service, with the endpoints that are passed as arguments during the creation of a VM.

### Obtaining Metadata

In some examples, for each service interface 1, a WSDL file I.wsdl is accessed describing the endpoints and their input and output types. Such WSDL files may be generated automatically when the interface for the endpoint is compiled, and are typically used to auto-generate proxy code for accessing the endpoint. The information contained in each WSDL file is compiled to an ML record; in this example, this compiled endpoint metadata is as follows:

```
let payment:service =
  {sname = “Payment”;
  ops = [{opname = “AuthorizePayment”;
    action = “http://tempuri.org/IPayment/AuthorizePayment”;
    input = “ProgrammingIndigo.Payment”;
    output = “string”}]}
let orderProc:service =
  {sname = “OrderProcessing”;
  ops = [{opname = “SubmitOrder”;
    action = “http://AdventureWorks/IOrderProcessing/SubmitOrder”;
    input = “ProgrammingIndigo.Order”;
    output = “unit”}]}
let orderEntry:service =
  {sname = “OrderEntry”;
  ops = [{opname = “SubmitOrder”;
    action = “http://AdventureWorks/IOrderEntry/SubmitOrder”;
    input = “ProgrammingIndigo.Order”;
    output = “string”}]}
```

For instance, a payment endpoint exposes a method AuthorizePayment, with a SOAP action attribute http://tempuri.org/IPayment/AuthorizePayment”; the method takes as input an argument of type ProgrammingIndigo.Payment and returns a result of type string.

Using these endpoint metadata, the metadata for a complete application may be defined. For our example, the following metadata describes all the resources available to server farm management scripts.

```
let m:metadata =
  [VM {vmname = “OrderEntry”; disk = “OrderW2K3.vhd”;
    inputs = [payment; orderProc];
    outputs = [(“/OrderEntry.svc”,orderEntry)]};
  VM {vmname = “OrderProc”; disk = “ProcW2K3.vhd”;
    inputs = [ ];
    outputs = [(“/OrderProc.svc”,orderProc)]};
  VM {vmname = “Payment”; disk = “PaymentW2K3.vhd”;
    inputs = [ ];
    outputs = [(“/Payment.svc”,payment)]};
  Import {name = “Payment1”;
    url = “http://creditagency1.com/CA/service.svc”;
    service = payment};
  Import {name = “Payment2”;
    url = “http://creditagency2.com/CA/service.svc”;
    service = payment};
  Export {name = “OrderEntry”;
    url = “http://localhost:8080/OE/service.svc”;
    service = orderEntry}]
```

Each VM record defines a role in terms of a VM name, a disk image file accessible from the server 206, a list of imported endpoints, and a list of exported services. For example, the OrderEntryVM role is defined by the file OrderW2K3.vhd, which holds a disk image; it takes two endpoints as input, described by payment and orderproc, and exports a single service OrderEntry consisting of a single endpoint, described by submit, at a local URI/OrderEntry.svc within the VM. This metadata is compiled from an XML file config.xml that may be at the root directory of each disk image (OrderW2K3.vhd in this case).

Each Import record defines an external service that can be used by a script. For instance, the Payment1 service at the external URL http://creditagency1.com/CA/service.svc contains one endpoint described by payment. Conversely, each Export record defines an internal service that it is required to make available externally. Here, the service OrderEntry containing one endpoint described by orderEntry may be exported at the URL http://localhost:8080/OE/service.svc.

### Generating an Environment Interface: Em.mli

Given metadata m as above, Generator may create an environment interface as follows:
It extracts all the service metadata appearing in m: from the inputs or outputs of a VM, or from the service field of an Import or Export; then for each service with name S and operations O₁, . . . , Oₙ with input/output types (t₁ⁱ,t₁^{o}), . . . , (tₙⁱ,tₙ^{o}), it generates a type tS as type tS=(t₁ⁱ,t₁^{o}) endpoint× . . . ×(tₙⁱ,tₙ^{o}) endpoint
For each VM record, with name N, input services I₁, . . . , Iₙ and outputs O₁, . . . , Oₘ, it generates a function declaration val createNRole: t I₁→ . . . →t Iₙ→(vm×(t O₁× . . . ×t Oₘ))
For each Import record, with name N and imported service S, it generates a function declaration
val importN: unit→tS
For each Export record, with name N and exported service S, it generates a function declaration
val exportN: tS→unit

For example, given the metadata m for our example application, Generator creates the Em.mli file shown above under the sub heading “Environment Interface: Em.mli”.

### Generating the Environment Proxy: Em-c.ml

Given metadata m, Generator creates an environment proxy as follows:
It generates types tS for each service in m as in Em.mli;
For each VM record, with name N, disk image file f, input services I₁, . . . , Iₙ and outputs O₁, . . . , Oₘ, Generator defines a function
   let createNRole (x₁:t I₁) . . . (xₙ:t Iₙ)=let (vm[y₁:t O₁, . . . , yₘ:t Oₘ])=Proxy.startVM fx₁ . . . xₙ in (vm[y₁, . . . , yₘ])

Here, the function call Proxy.startVM contacts the server 206 which, in turn, uses the Virtual Server API to start a new VM from the disk image f, and configures it with the input services x₁ . . . xₙ.
For each Import record, with name N, uri U and imported service S, Generator creates a function definition
   val importN( )=let y:tS=Proxy.startForwardingIntermediary U in y

The function call Proxy.startForwardingIntermediary contacts the server 206 which sets up an intermediary 207 on the server at the endpoint address y, it then forwards all calls made to y to the external address U.
For each Export record, with name N, address U, and exported service S, Generator creates a function definition
   val exportN(x:tS)=let y:tS=Proxy.startExportedIntermediary U x in ( )

The code is similar to the import case; the server 206 sets up an externally addressable intermediary at U that forwards all service calls to x.

Hence, given the metadata m in the example being discussed, Generator creates a module Em-c.ml that implements Em.mli by calling the Server 206.

### Scripts Respect Endpoint Types

Given metadata m, let an m-script (a server farm management script) be a program that is well-typed given interfaces:
B.mli, the fixed part of the service combinator API; and
Em.mli, access to the roles and external endpoints specified in m.

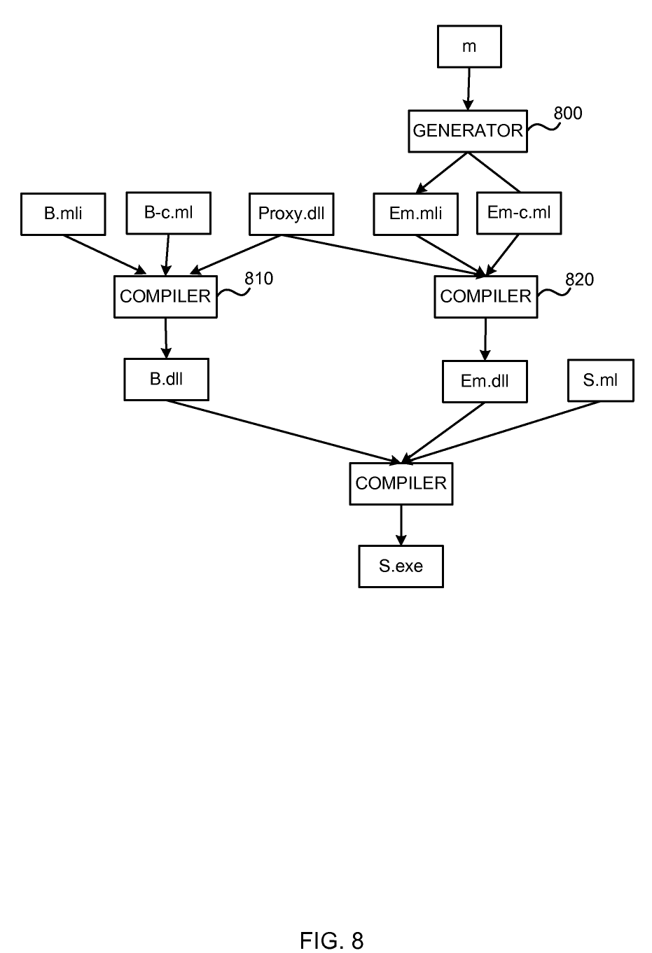

FIG. 8 shows how Generator 800 is used together with conventional compilation 810, 820 to build a Manager 205 executable from an m-script S.ml. Typechecking during compilation establishes that S.ml is indeed an m-script.

The use of the typed interface implemented by Generator provides a useful safety property: the resulting Manager 205 is guaranteed to introduce no type errors.

Consider the following definitions.
Each endpoint can be assigned a type (α,β)endpoint. Externally addressable endpoints are assigned types by metadata. Internal endpoints are assigned types when constructed by the methods described herein.
An entity respects an endpoint of type (α,β)endpoint if and only if (1) each request sent by the entity to the endpoint has type α, and (2) each response sent by the entity, in response to a request on the endpoint, has type β.

It is then possible to state a safety property as follows. Consider some metadata m describing some external endpoints and some disk images. Consider also an I-script S.ml, compiled to a manager. If
all remote clients and servers respect the endpoints in m, and
the disk images respect the endpoints they import and export then all entities arising during a run of the Manager 205 respect all endpoints.

Many interconnection errors, where servers or intermediaries are connected to the wrong endpoints, lead to entities not respecting endpoints, that is, to requests or responses of unexpected types. These errors may arise at initial configuration, or during subsequent reconnections. The above safety property guarantees, by static typechecking, that such errors cannot arise.

### Exemplary Computing-Based Device

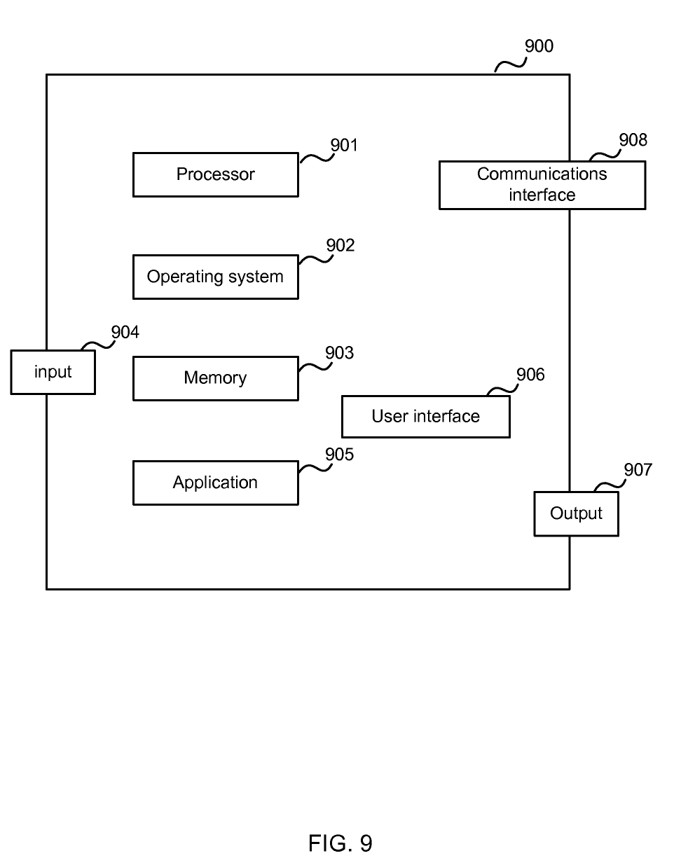

FIG. 9 illustrates various components of an exemplary computing-based device 900 which may be implemented as any form of a computing and/or electronic device, and in which embodiments of a server farm management system may be implemented.

The computing-based device 900 comprises one or more inputs 904 which are of any suitable type for receiving media content, Internet Protocol (IP) input, metadata about servers in a server farm or other input. The device also comprises communication interface 908.

Computing-based device 900 also comprises one or more processors 901 which may be microprocessors, controllers or any other suitable type of processors for processing computing executable instructions to control the operation of the device in order to manage a server farm. Platform software comprising an operating system 902 or any other suitable platform software may be provided at the computing-based device to enable application software 905 to be executed on the device.

The computer executable instructions may be provided using any computer-readable media, such as memory 903. The memory is of any suitable type such as random access memory (RAM), a disk storage device of any type such as a magnetic or optical storage device, a hard disk drive, or a CD, DVD or other disc drive. Flash memory, EPROM or EEPROM may also be used.

An output is also provided such as an audio and/or video output to a display system integral with or in communication with the computing-based device. The display system may provide a graphical user interface, or other user interface of any suitable type although this is not essential.

The term ‘computer’ is used herein to refer to any device with processing capability such that it can execute instructions. Those skilled in the art will realize that such processing capabilities are incorporated into many different devices and therefore the term ‘computer’ includes PCs, servers, mobile telephones, personal digital assistants and many other devices.

The methods described herein may be performed by software in machine readable form on a storage medium. The software can be suitable for execution on a parallel processor or a serial processor such that the method steps may be carried out in any suitable order, or simultaneously.

This acknowledges that software can be a valuable, separately tradable commodity. It is intended to encompass software, which runs on or controls “dumb” or standard hardware, to carry out the desired functions. It is also intended to encompass software which “describes” or defines the configuration of hardware, such as HDL (hardware description language) software, as is used for designing silicon chips, or for configuring universal programmable chips, to carry out desired functions.

Those skilled in the art will realize that storage devices utilized to store program instructions can be distributed across a network. For example, a remote computer may store an example of the process described as software. A local or terminal computer may access the remote computer and download a part or all of the software to run the program. Alternatively, the local computer may download pieces of the software as needed, or execute some software instructions at the local terminal and some at the remote computer (or computer network). Those skilled in the art will also realize that by utilizing conventional techniques known to those skilled in the art that all, or a portion of the software instructions may be carried out by a dedicated circuit, such as a DSP, programmable logic array, or the like.

Any range or device value given herein may be extended or altered without losing the effect sought, as will be apparent to the skilled person.

It will be understood that the benefits and advantages described above may relate to one embodiment or may relate to several embodiments. It will further be understood that reference to ‘an’ item refer to one or more of those items.

The steps of the methods described herein may be carried out in any suitable order, or simultaneously where appropriate. Additionally, individual blocks may be deleted from any of the methods without departing from the spirit and scope of the subject matter described herein. Aspects of any of the examples described above may be combined with aspects of any of the other examples described to form further examples without losing the effect sought.

It will be understood that the above description of a preferred embodiment is given by way of example only and that various modifications may be made by those skilled in the art. The above specification, examples and data provide a complete description of the structure and use of exemplary embodiments of the invention. Although various embodiments of the invention have been described above with a certain degree of particularity, or with reference to one or more individual embodiments, those skilled in the art could make numerous alterations to the disclosed embodiments without departing from the spirit or scope of this invention.

1. A method of managing a server farm comprising:
obtaining metadata about the server farm;
generating a typed environment interface using the metadata, the environment interface being an application programming interface to server farm resources;
receiving at least one script formed at least using the environment interface;
carrying out typechecking on the received script; and
if typechecking is successful, executing the script in order to manage the server farm.

2. A method as claimed in claim 1 wherein the server farm comprises a plurality of servers each having a server role and wherein the process of obtaining the metadata comprises, for each server, obtaining a typed representation of the role of that server as at least one service provided via at least one endpoint of the server by any of importation and exportation.

3. A method as claimed in claim 2 wherein the process of obtaining the metadata further comprises accessing a disk image for each server, that disk image comprising input and output types for each endpoint implemented by that server.

4. A method as claimed in claim 2 wherein the process of obtaining the metadata further comprises obtaining information about any endpoints external to the server farm available for use by the server farm.

5. A method as claimed in claim 2 wherein the process of obtaining the metadata further comprises obtaining information about any endpoints at which server roles of the server farm may be exported outside the server farm.

6. A method as claimed in claim 2 wherein the step of generating the typed environment interface comprises forming typed representations of request and response types associated with each endpoint and forming typed functions for accessing resources of the server farm.

7. A method as claimed in claim 1 which further comprises accessing a library of typed service combinators those service combinators providing operations for managing the server farm.

8. A method as claimed in claim 1 wherein the process of receiving a script comprises receiving a script formed using the environment interface and at least one service combinator.

9. A method as claimed in claim 8 wherein the at least one service combinator provides an operation selected from any of: creating a virtual machine, interconnecting virtual machines using typed endpoints, creating an intermediary, provisioning servers of the server farm in response to an event, reconfiguration of servers of the server farm in response to an event.

10. A method of managing a server farm comprising:
obtaining metadata about the server farm;
generating an environment interface using the metadata, the environment interface being an application programming interface to server farm resources;
receiving at least one script formed at least using the environment interface and a reference intermediary service combinator;
executing the script in order to manage the server farm such that a reference intermediary is created which is arranged to forward any request sent to its endpoint to another endpoint which may be updated.

11. A method as claimed in claim 10 wherein the process of receiving a script comprises receiving a script comprising an event handling mechanism arranged to update the endpoint to which the reference intermediary forwards when a specified event occurs.

12. A method as claimed in claim 10 wherein the process of generating the environment interface comprises generating a typed environment interface.

13. A method as claimed in claim 12 wherein the reference intermediary service combinator is typed and wherein the method further comprises carrying out typechecking on the received script and only executing the script if typechecking is successful.

14. A method as claimed in claim 10 wherein the process of receiving at least one script comprises receiving a script comprising a snapshot service combinator arranged to save and restore a snapshot being a file system representation of a virtual machine state.

15. A method as claimed in claim 10 wherein the process of receiving at least one script comprises receiving a script comprising a load balancing service combinator arranged to form an intermediary arranged to forward a message sent to its endpoint to any one of a specified plurality of endpoints on the basis of a specified strategy.

16. A method of managing a server farm comprising:
obtaining metadata about the server farm;
generating an environment interface using the metadata, the environment interface being an application programming interface to server farm resources;
receiving at least one script formed at least using the environment interface and a load balancing service combinator;
executing the script in order to manage the server farm such that an intermediary is created which is arranged to forward any request sent to its endpoint to any of a plurality of specified endpoints on the basis of a specified strategy.

17. A method as claimed in claim 16 wherein the process of generating the environment interface comprises generating a typed environment interface.

18. A method as claimed in claim 16 wherein the load balancing service combinator is typed and wherein the method further comprises carrying out typechecking on the received script and only executing the script if typechecking is successful

19. A method as claimed in claim 16 wherein the process of obtaining metadata about the server farm comprises obtaining metadata about a plurality of servers in the server farm at least some of those servers being virtual machines.

20. A method as claimed in claim 19 wherein the process of obtaining metadata about the server farm comprises, for each server, obtaining a typed representation of a role of that server as at least one service provided via at least one endpoint of the server by any of importation and exportation.
